(19) United States
(12) Patent Application Publication
(10) Pub. No.: US 2007/0291078 A1
(43) Pub. Date: Dec. 20, 2007

(54) Droplet Deposition Apparatus and Method of Manufacture

(75) Inventor: Paul R. Drury, Hertfordshire (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XXAAR TECHNOLOGY LIMITED, CAMBRIDGESHIRE UNITED KINGDOM (GB)

(21) Appl. No.: 11/631,201

(22) PCT Filed: Jul. 4, 2005
(86) PCT No.: PCT/GB05/02617

§ 371 Date: Apr. 19, 2007

(30) Foreign Application Priority Data
Jul. 2, 2004 (GB) 0414867.2

(51) Int. Cl. B41J 2/145

(52) U.S. Cl. 347/41; 347/47

(57) ABSTRACT

To increase manufacturing yield, an array of ejection chambers in an inkjet printer includes at least one redundant ejection chamber. For each ejection chamber, there is a possible nozzle window, and these nozzle windows overlap. The ejection chambers are tested prior to nozzle formation to identify any non-functioning chambers, appropriately positioned within the respective nozzle windows to form uniformly spaced dots on a substrate, with at least one ejection chamber.

The present invention relates to droplet deposition apparatus and in particular inkjet print heads.

There is a demand for digital printers having a wide print heads. In certain applications the print head extends across the full width of the printed pate offering high throughput with excellent quality.

In an inkjet printer of this character, having the necessarily large number of closely spaced ink chambers and nozzles, there will always be a risk of failure, of one or more nozzles, whether as a consequence of a manufacturing error or through nozzle blockage or other failure in use. There is additionally the risk of failure of the actuators which effect droplet ejection from the ink chambers or the drive circuits or electrical contacts which provide drive signals to the actuators.

It will be possible to detect and discard manufactured print heads having even a single failed nozzle, actuator, drive circuit or electrical contacts. However, because of the very large number of nozzles in each print head, and because of the manufacturing techniques, such quality control measures would likely lead to an uneconomic manufacturing yield.

In use of the print head, failure of even one of the print elements can lead to perceptible print artefacts, because of the spatial correlation of the artefacts as the printed substrate is indexed past the print head.

Accordingly it is an object of the present invention to provide improved methods of printing and improved print heads that are able to conceal artefacts arising from manufacturing defects or other departures from standard print performance across a print row.

According to one aspect of the present invention there is provided a droplet deposition apparatus comprising: an array of N ejection chambers, each chamber comprising a nozzle window, the nozzle window of an ejection chamber overlapping the nozzle window of at least one other ejection chamber in a swath direction, nozzles formed within the bounds of said nozzle windows, the nozzle arrangement being such that with the use of not more than N−1 of said ejection chambers droplets can be ejected through said nozzles to form dots on a substrate at a predetermined and uniform dot spacing in said swath direction.

Actuators which effect droplet ejection may be provided in close proximity with the ejection chambers. The actuators may deform a portion of the chamber thereby creating pressure fluctuations. The actuators may heat the fluid in the pressure chamber to generate a bubble that causes droplet ejection.

The non-ejecting chamber may be located at the ends of the array, or more preferably is located within the array. The nozzle window of the non-ejecting chamber may or may not be formed with a nozzle.

The nozzle widows may overlap for example 1, 2, 3, 4, 8, 16 or more other nozzle windows—even up to every nozzle window within the array.

In one embodiment a plurality of nozzles are provided in a respective nozzle window. These nozzles may, for example, be arranged as a linear array of two or three or as a triangular, square or hexagonal arrangement.

Each array may be formed in a module and a plurality of modules arranged together to provide either a longer array or a plurality of parallel arrays or both.

The ejection chambers may be elongate with the direction of elongation parallel to the swath direction. The array preferably extends at an angle to said swath direction, said angle preferably being between 30° and 90°, however other arrangements of the array or arrays are equally possible.

In a second aspect of the present invention there is provided a method of manufacturing droplet deposition apparatus, said method comprising the steps: providing an array of N ejection chambers, each ejection chamber comprising a nozzle window, the nozzle window of an ejection chamber overlapping the nozzle window of at least one other ejection chamber in a swath direction, testing the functionality of each ejection chamber and in accordance with the results of said testing forming nozzles within the bounds of not more than N−1 of said nozzle windows, the nozzle arrangement being such that droplets ejected from said ejection chambers through said nozzles form dots on the substrate at a predetermined and uniform dot spacing in the swath direction.

In a third aspect the present invention consists in a component for use in the manufacture of droplet deposition apparatus, the component comprising an array of N ejection chambers, each ejection chamber comprising a nozzle window, the arrangement being such that taking any selection of N−1 of the ejection chambers, a respective nozzle can be positioned within the nozzle window of each selected chambers, with the projection of said nozzles on a print line being uniformly spaced.

The nozzle window is defined as an area of an ejection chamber which, if it contains a nozzle, will eject a drop of average size and velocity to all the other drops ejected from chambers in the array when the actuators are all actuated by an identical waveform. Velocity is measured by drop position on a substrate, whilst size is measured by dot area on the substrate.

Each ejection chamber may be tested by e.g. a displacement or resonance measurement using a laser interferometer or other appropriate method.

The present invention will now be described by way of example only with respect to the accompanying drawings in which:—

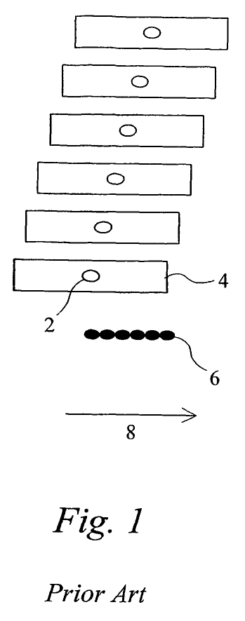

FIG. 1 is a schematic view of an inkjet print head according to the prior art.

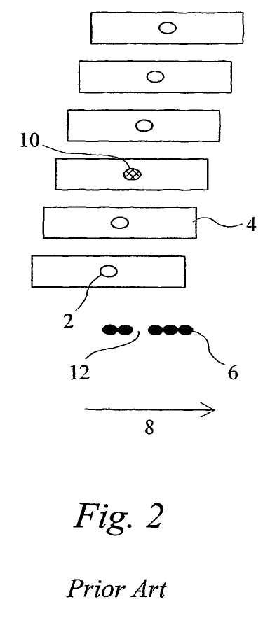

FIG. 2 is a schematic view similar to FIG. 1 illustrating the effect of a manufacturing defect.

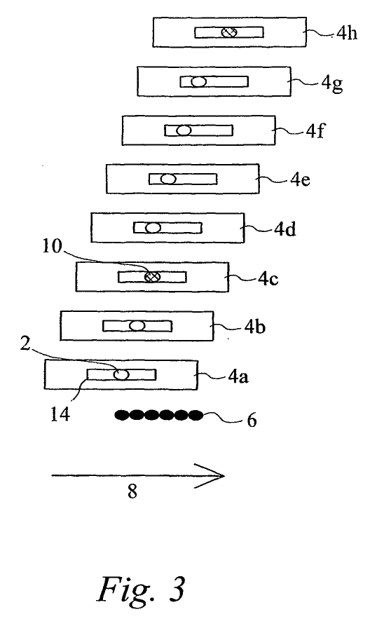

FIG. 3 is a schematic view of an inkjet printhead.

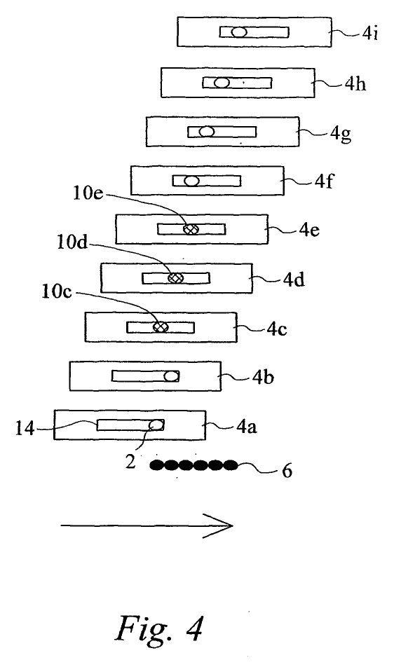

FIG. 4 is a schematic view similar to FIG. 3 illustrating the manner in which more than one manufacturing defect can be accommodated.

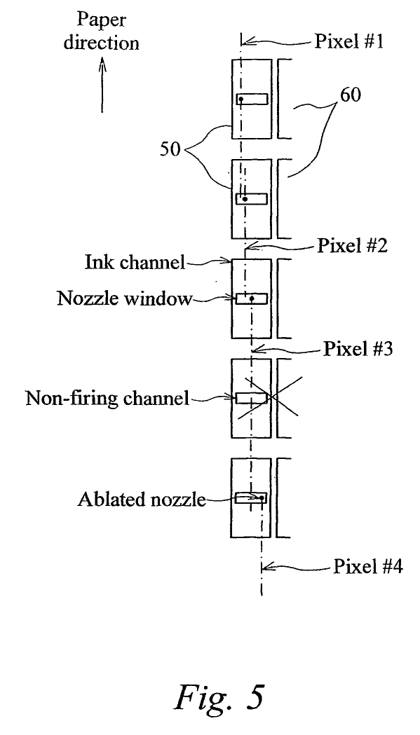

FIG. 5 is a schematic view of a nodule arrangement according to an embodiment of the present invention.

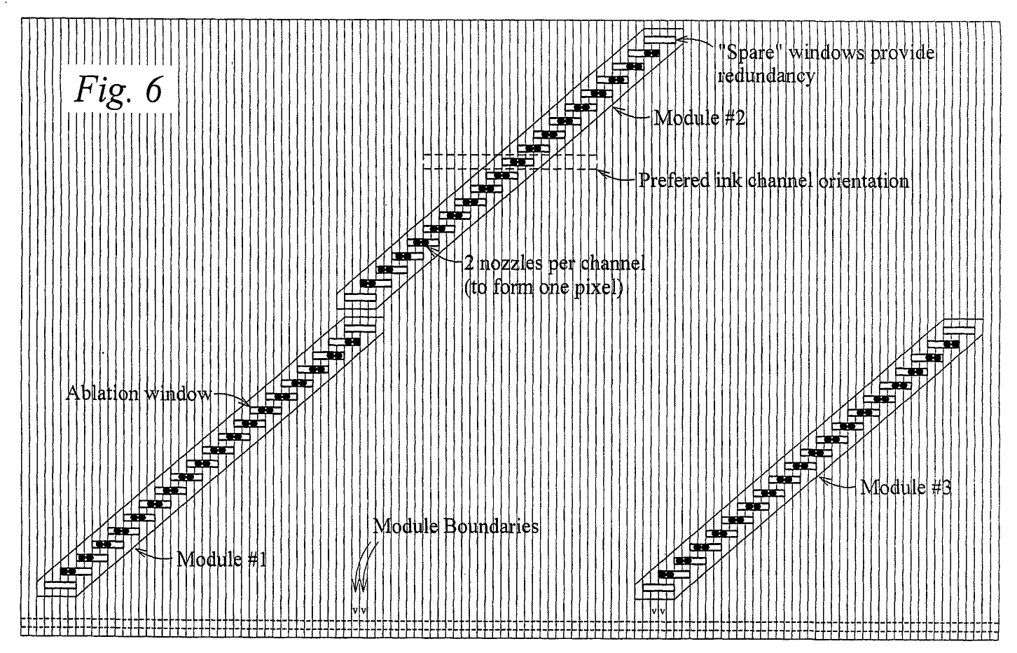

FIG. 6 is a schematic view of an inkjet print head according to a further embodiment of the present invention.

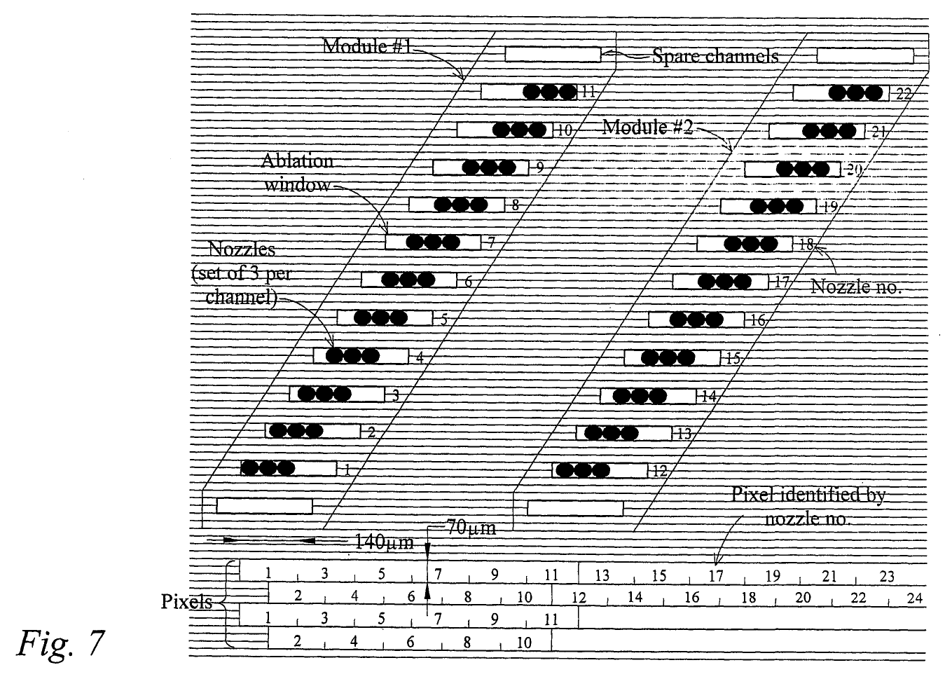

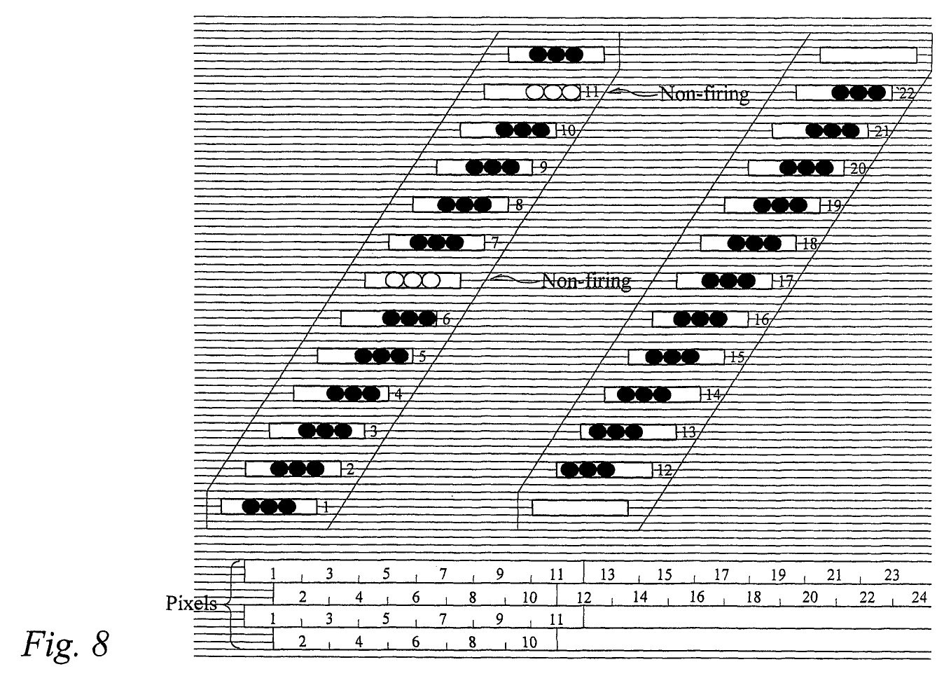

FIGS. 7 and 8 are schematic views of an inkjet printer according to a further embodiment.

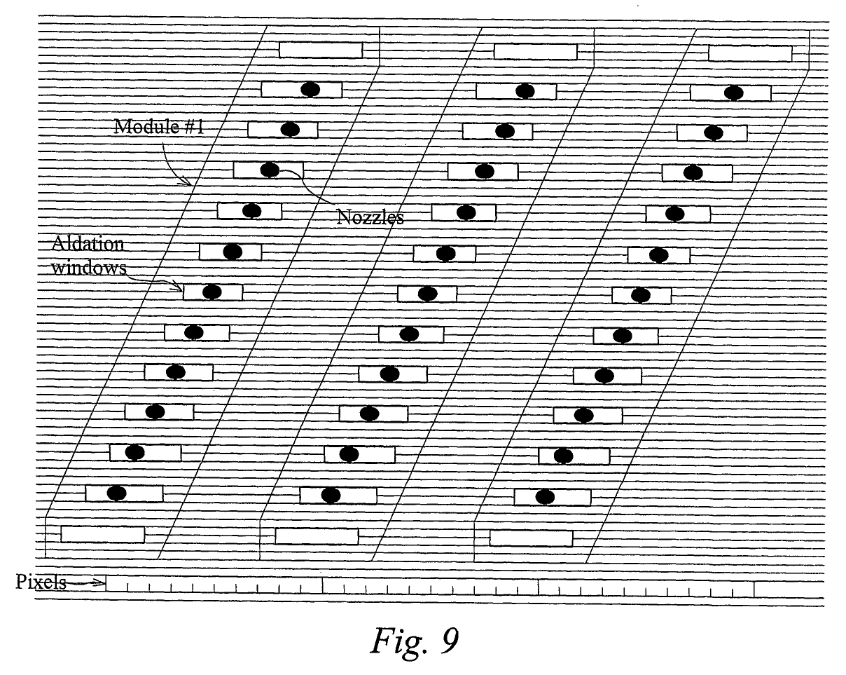

FIGS. 9, 10 and 11 are schematic views of a further embodiment.

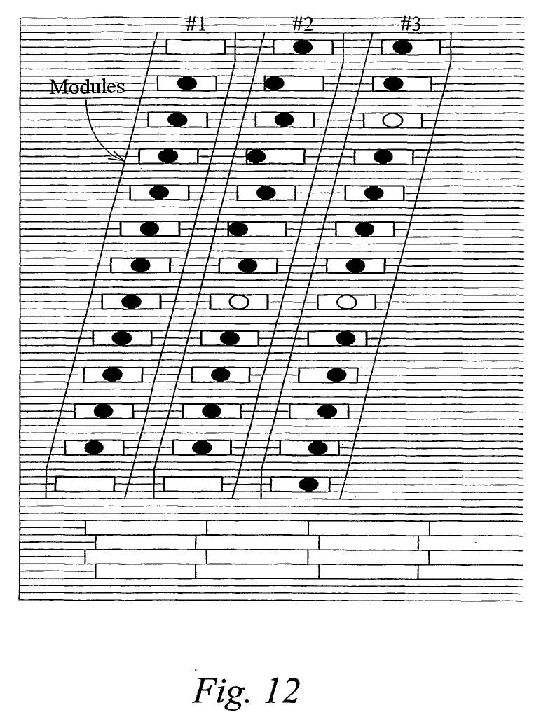

FIG. 12 is a schematic view of a further embodiment.

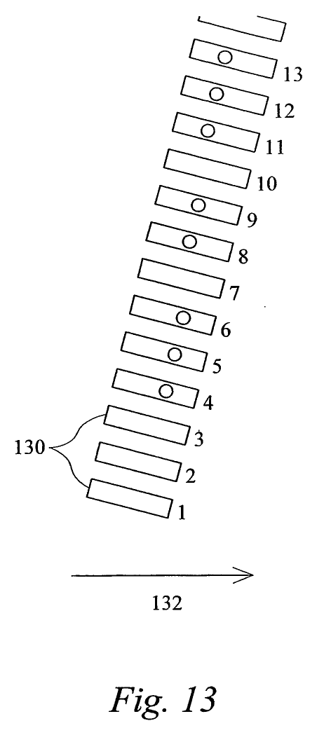

FIG. 13 is a schematic view of a further embodiment illustrating an alternative array of channels.

FIG. 1 is a schematic view of an inkjet print head having an array of channels 4. Nozzles 2 are positioned at the same position in each channel and are capable of printing a swath 6 of dots on a substrate. The swath extends in a swath direction 8.

As can be seen from FIG. 2 a defective nozzle or actuator 10 results in a print artefact 12 within the swath 6. This is unacceptable for most applications and requires the print head be scrapped.

Turning now to FIG. 3, which depicts a print head according to the present invention, it has been found that the ejection characteristics of an ejection chamber are determined, at least in part by the position of the nozzles in relation to the chamber.

It has been found by the applicant that there is for each ejection chamber a nozzle window. The nozzle window is the area of that face of the ejection or associated chamber which is to receive the nozzle, within which window an average nozzle for the array may be placed without a detrimental affect on a droplet ejected through the nozzle. By detrimental effect we mean a visible or material difference on a droplet ejected from an average nozzle. Visible differences are formed by such things as differences in drop speed or drop volume.

The nozzle window overlaps at least one other nozzle window in the swath direction. The ejection chambers can be pre-tested before nozzles are formed in the nozzle window. By pre-testing the ejection chambers prior to forming the nozzles in the nozzle window it is possible to determine whether a print artefact is likely to occur.

The nozzle window may be determined before a nozzle plate is attached to an ejection chamber or once a nozzle plate is attached to an ejection chamber. Nozzles may therefore be formed either before or after a nozzle plate is attached to an ejection chamber.

In FIG. 3, ejection chamber 4c is deficient. Under the prior art approach this would result in a print artefact. However, as the nozzle window of 4d overlaps the nozzle window of 4c it is possible to correct the artefact with a dot formed by a droplet ejected from ejection chamber 4d.

In order to allow for defective ejection chambers to be replaced in this way it is necessary for additional redundant ejection chambers to be provided in the array. Where, for example, not all the ejection chambers are required, as in ejection chamber 4h of FIG. 3, the un-required ejection chambers may be treated as if they are non-working ejection chambers.

As can be seen from FIG. 4, by varying the position of the first nozzle in the first ejection chamber of the array it is possible to overcome an artefact caused by a plurality of consecutive failed ejection chambers. The total number of failed ejection chambers that may be overcome in a single array is dependent on both the size of the nozzle window and the number of ejection chambers available to replace the failed ejection chambers.

FIG. 5 shows a series of channels 50 in a plurality of rows 60 of an inkjet module. Conventionally four rows each having 90 dpi resolution might be interleaved to provide 360 dpi. However, in the case of a single non-firing channel in any row, the entire module would be scrap. The invention requires the inclusion in this example of a fifth row identical to the others. Non-operative channels can be detected during manufacture. Then a nozzle will be ablated in the fifth row at the appropriate location to provide a droplet to replace the droplet from the defective channel. Additional cost incurred in forming the fifth row is likely to be less than cost of scrap in the case of a our row device without redundancy.

The nozzle windows are wide enough to allow a nozzle to be ablated in any row to address the four pixels allocated to the row of five actuator channels. An actuator intended to operate, say 64 nozzles may have additional active devices. The nozzle ablation process would skip non functional channels but retain the pixel pitch where appropriate.

The ability to use imperfect devices significantly increases the manufacturing yield for any product. The proposed scheme, in its simplest form allows just one non-operational device per actuator array. The concept though might be easily extended to accommodate devices with larger numbers of defective elements. Fundamentally, the scheme requires that each active element of the module can be tested to verify its level of operation. Such a test might be a displacement measurement using a laser interferometer or a resonance measurement using the same equipment or an electrical method employing the electrodes to be used subsequently in operation of the device. In turn the driver chip must be capable of being programmed such that the image data can be assigned to relevant outputs such that non-operation elements receive either no data or non-firing data. Accordingly, the control for the laser nozzle ablation must be programmed to place nozzles in the appropriate channels and to skip non-firing elements.

FIG. 6 shows 3 modules each supporting 18 pixels, although these numbers will of course be much larger in practice. Each channel has an ablation window, this being an area in which nozzles can be ablated (channels not shown in FIG. 6). The modules have a total of 20 ablation windows, the ones at each end of the module array are spare (meaning unablated in the case that no faulty element is present). The illustration shows now a full swathe is printed where redundancy us not required.

FIG. 7 shows an embodiment in which three nozzles are formed in each channel, the nozzles being in a line array. In this arrangement (and also with the to arrangement of FIG. 6) it is possible to implement additionally the invention disclosed in EP 1 552 469, the content of which is hereby incorporated by reference. This uses multiple nozzles or other nozzle arrangements to form “super pixels”. For each row of input pixels two superimposed rows of continuous super pixels are printed, each print pixel being capable of receiving print contributions for N super pixels. In one example the super pixels are twice the width of the input pixels and are row of super pixels is offset by half a super pixel width from the new row of super pixels. Redundancy is thus provided against the loss of a print element. It is proposed that arrangements according to the present invention be used to allow imperfect devices to be assembled into wide arrays (so increasing yields significantly) and also, that the invention of EP 1 552 469 be used to address operational (in the field) failures so improving the “reliability/lifetime” of the array (or printhead).

FIG. 8 shows the same layout with the first module having two non-firing channels. The nozzle ablation pattern is modified accordingly and results in the construction of a full swath.

In a simple form, a layout according to the present invention appears as is shown in FIG. 9. Any number of drop ejection elements can be built into each module, 11 per module are shown.

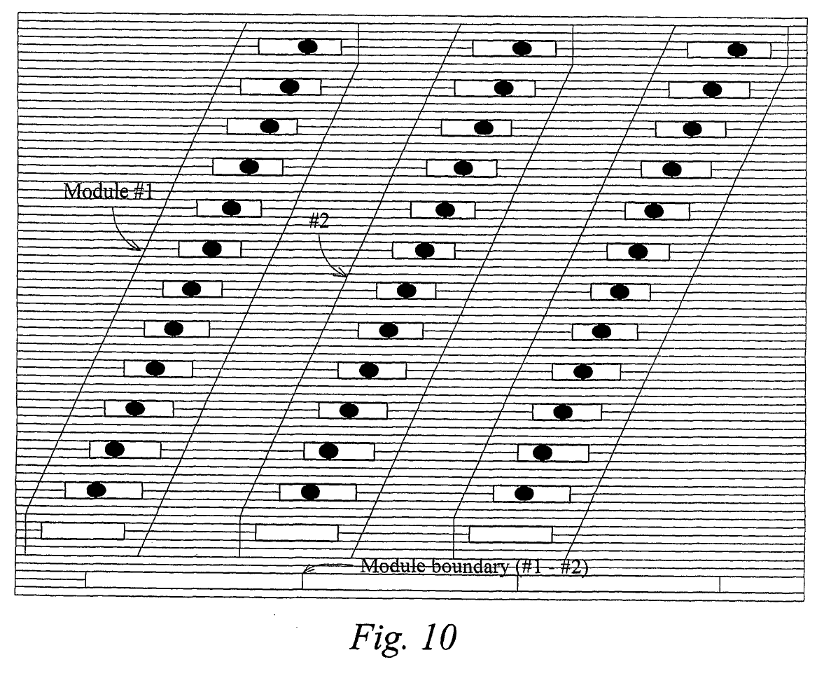

FIG. 10 shows how a nozzle ablated in a spare ablation window might be used to trim or optimize the image in the boundary between modules. The volume of ink delivered to pixel 12 from nozzles 12a and 12b might be used to correct for volume or placement variations at the boundary between modules.

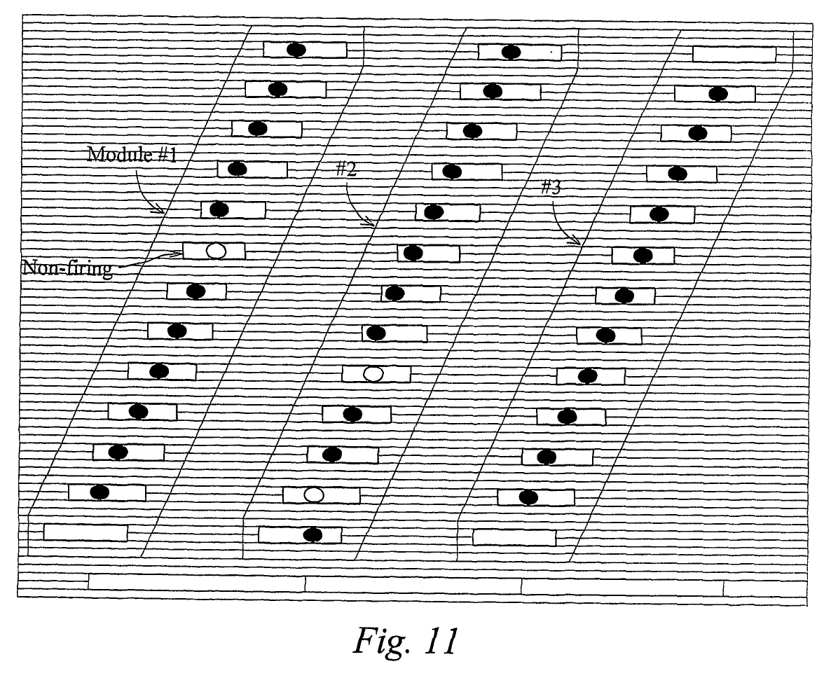

Yield is improved through the ability to use imperfect modules. This is shown in FIG. 11 where modules #1 and #2 contain non-firing elements. The ablation process is programmed to provide a continuous pixel swath by skipping the known non-firing elements.

In FIG. 11, the ablation process provides a standard nozzle arrangement in which neighbouring chambers tend to correspond to neighbouring pixels in the swath. It has been found however, that the nozzle pattern can advantageously be selected based on knowledge of the characteristics of print performance across an array of chambers. Where, for example, a region of the array is found to have non-uniform characteristics, it is possible according to certain embodiments of the invention to select a nozzle pattern that acts to disperse the effect of the non-uniformity. Considering the case where a pair of neighbouring actuators or channels are known to be operational, but to have reduced performance, a nozzle pattern can be selected such that those two actuators do not correspond to neighbouring pixels in the swath. This has the effect of dispersing or separating the non-uniformity of the actuators in the printed image, thereby reducing the visibility of any potential defect. The extent to which pixels from neighbouring chambers can be separated on the page, or alternatively the number of adjacent chambers which can be ‘re-ordered’ in this way will depend on the extent of the nozzle window.

In FIG. 12, module #1 has all nozzles firing. Modules #2 and #3 have non-firing elements each showing alternative nozzle patterns to achieve the full pixel swath. It can be seen that the nozzle pattern in module #2 has an ‘irregular’ pattern which results in the printed pixels from certain neighbouring channels being non-adjacent in the printed swath. Although illustrated in FIG. 12 with a square pixel pattern, this feature can be used advantageously in conjunction with “super pixels” as described above.

Where the print head is of the type referred to in the art as a side shooter, with the nozzle formed in an elongate side face of the ejection chamber or channel, the nozzle window will extend over a portion of the length of that elongate side face. This is the construction assumed inmost of the previously described embodiments. It is also possible to implement the present invention with a so called end shooter, where the nozzle is formed in an end face of an elongate channel. In that case the nozzle window may occupy essentially the entirety of that end face.

Such an arrangement is shown in FIG. 13 where elongate channels (seen in the Figure only through respective end faces 130) have a length which is perpendicular to the plane of the paper.

With a native channel pitch of 141 micrometers, the array channel 130 is inclined so as to provide a pixel pitch (along the swath direction 132) of 35 micrometers (720 dpi). In the arrangement depicted, channels numbered 7 and 10 have by test been identified as being non-functional. Nozzles are therefore ablated in channels 4, 5, 6, 7, 9, 11, 12, 13 (with channels 1, 2 and 3 also being redundant in this application). It will be noted that the nozzles in channels numbered 8 and 9 remain in their primary positions, that it to stay on a longitudinal center line of the channel. The nozzles in channels 4, 5 and 6 are offset in the nozzle window represented by the end face of the channel 130. The nozzles formed in channels 11, 12 and 13 are similarly offset in the nozzle window, but in the opposite direction. It will be observed that in this way, the projection of the nozzles 4, 5, 6, 8, 9, 11, 12, 13 on the swath direction 132 are uniformly spaced.

This invention has been described by way of examples only and a variety of modifications are possible without departing from the scope of the invention. Each feature disclosed in the description, and (where appropriate) the claims and drawings may be provided independently or in any appropriate combination. Whilst the invention has particular applicability to arrangements of elongated ink channels where one wall of each channel is formed of piezoelectric material, the invention will find utility in many other arrangements including other piezoelectric arrangements and non-piezoelectric arrangements such as thermal inkjet printing.

1. Droplet deposition apparatus comprising: an array of N ejection chambers, each chamber comprising a nozzle window, the nozzle window of an ejection chamber overlapping the nozzle window of at least one other ejection chamber in a swath direction, nozzles formed within the bounds of said nozzle windows, the nozzle arrangement being such that with the use of not more that N−1 of said ejection chambers, droplets can be ejected through said nozzles to form dots on a substrate at a predetermined and uniform dot spacing in said swath direction.

2. Droplet deposition apparatus according to claim 1, in which not more than N−1 of said ejection chambers are formed with nozzles.

3. Droplet deposition apparatus according to claim 1, and having actuators which effect droplet ejection, the actuators serving to deform a portion of the chamber, thereby creating pressure fluctuations.

4. Droplet deposition apparatus according to claim 1, wherein a plurality of nozzles are provided in a respective nozzle window.

5. Droplet deposition apparatus according to claim 1, wherein the ejection chambers are elongate with the direction of elongation lying parallel to the swath direction.

6. Droplet deposition apparatus according to claim 1, wherein the ejection chambers are elongate with the direction of elongation lying orthogonal to the swath direction.

7. Droplet deposition apparatus according to claim 1, wherein said nozzle arrangement is chosen such that dots formed by droplets ejected from at least some adjacent chambers are non-adjacent in the printed swath.

8. Method of manufacturing droplet deposition apparatus, said method comprising the steps: providing an array of N ejection chambers, each ejection chamber comprising a nozzle window, the nozzle window of an ejection chamber overlapping the nozzle window of at least one other ejection chamber in a swath direction, testing the functionality of each ejection chamber and in accordance with the results of said testing forming nozzles within the bounds of not more than N−1 of said nozzle windows, the nozzle arrangement being such that droplets ejected from said ejection chambers through said nozzles form dots on the substrate at a predetermined and uniform dot spacing in the swath direction.

9. Method according to claim 8, wherein the step of forming nozzles comprises the step of forming apertures in a nozzle plate previously attached to the array of ejection chambers.

10. Method according to claim 8, wherein the step of forming nozzles comprises the step of forming apertures in a nozzle plate and subsequently attaching the nozzle plate to the array of ejection chambers.

11. Method according to claim 8, wherein more than one nozzle is provided in a nozzle window.

12. Method according to claim 8, wherein said nozzle arrangement is chosen so as to disperse along the swath the visible effects of non-uniformity of ejection chamber functionality along the array of ejection chambers.

13. Method according to claim 8, wherein said nozzle arrangement is chosen such that dots formed by droplets ejected from at least some adjacent chambers are non-adjacent in the printed swath.

14. A component for use in the manufacture of droplet deposition apparatus, the component comprising an array of N ejection chambers, each ejection chamber comprising a nozzle window, the arrangement being such that taking any selection of N−1 of the ejection chambers, a respective nozzle can be positioned within the nozzle window of each selected chambers, with the projection of said nozzles on a print line being uniformly spaced.
